(19) United States
(12) Patent Application Publication
(10) Pub. No.: US 2007/0084566 A1
(43) Pub. Date: Apr. 19, 2007

(54) Press-bonding apparatus and press-bonding method

(76) Inventors: Shingo Seki, Himeji-shi (JP); Koji Fujii, Tatsuno-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/545,464

(22) Filed: Oct. 11, 2006

(30) Foreign Application Priority Data
Oct. 12, 2005 (JP) 2005-297982
Oct. 20, 2005 (JP) 2005-305694

(51) Int. Cl. B30B 15/34

(52) U.S. Cl. 156/583.1

(57) ABSTRACT

A press-bonding apparatus includes a backup member which supports a display panel, a heater tool which presses a wiring board, which is aligned at a predetermined position on the display panel via an adhesive member, toward the display panel between the heater tool and the backup member, and press-bonds the wiring board to the display panel, and a thermal resistor which is interposed between the backup member and the display panel.

### CROSS-REFERENCE TO RELATED APPLICATIONS

This application is based upon and claims the benefit of priority from prior Japanese Patent Applications No. 2005-297982, filed Oct. 12, 2005; and No. 2005-305694, filed Oct. 20, 2005, the entire contents of both of which are incorporated herein by reference.

### BACKGROUND OF THE INVENTION

1. Field of the Invention

The present invention relates generally to a press-bonding apparatus and a press-bonding method, and more particularly to a press-bonding apparatus and a press-bonding method for connecting a display panel, which includes a display area for displaying an image, and a wiring board by heating and pressing.

2. Description of the Related Art

A flat-panel display device includes a display panel having a display area for displaying an image, and a wiring board which is connected to the display panel. The wiring board is composed of, e.g. a tape carrier package (TCP) in which a driver IC is mounted on a flexible printed wiring board by a tape automated bonding (TAB) method.

In a press-bonding apparatus which connects the wiring board to the display panel, the wiring board is placed, via a bonding member such as an anisotropic conductive film (ACF), at a predetermined location on the display panel, for example, at a connection part having connection terminals that are led out to an end portion of a substrate, and the connection terminals on the display panel are aligned with electrodes on the wiring board. Thereafter, the aligned connection terminals and electrodes are pressed and heated, and thus the wiring board and the display panel are connected by thermal press-bonding (see, e.g. Jpn. Pat. Appln. KOKAI Publications No. 07-294954, No. 10-163276 and No. 2005-079399).

In recent years, with an increasing demand for reduction in thickness of display devices, a very thin insulating substrate with a thickness of, e.g. about 0.3 mm is, in many cases, used as an insulating substrate which is a structural component of the display panel. In the case where such a thin substrate is used, it is difficult to maintain, when the display panel is to be connected to the wiring board, an actual temperature which enables melting of a bonding member and sure bonding. Specifically, since the thin substrate has high heat radiation properties, the heat from a heater tool of the press-bonding apparatus tends to be easily radiated to a backup member which supports the display panel. Consequently, the bonding member cannot adequately be heated, and defective connection would occur.

On the other hand, if a set temperature for press-bonding the wiring board is raised, components (e.g. polarizers) which are already mounted on the display panel may adversely be affected. In addition, the amount of extension of the wiring board becomes unstable, leading to defective connection. If the heating temperature of the heater tool is varied, it is necessary to adjust, for instance, the parallelism of the heater tool relative to a to-be-bonded part. Hence, it is necessary to perform various adjustments in accordance with the thickness of a glass plate to be used, and a time-consuming work is required.

Moreover, in the case of using the thin substrate, if the thin substrate is pressed under the same pressure as in the prior art, the thin substrate may possibly be damaged.

### BRIEF SUMMARY OF THE INVENTION

The present invention has been made in consideration of the above-described problems, and the object of the invention is to provide a press-bonding apparatus and a press-bonding method, which can suppress, without raising a set temperature more than necessary, defective connection at a to-be-bonded part, and can prevent damage to a substrate which constitutes a to-be-bonded part.

According to a first aspect of the present invention, there is provided a press-bonding apparatus comprising: a backup member which supports a to-be-bonded part; a heater tool which presses and heats the to-be-bonded part, with the to-be-bonded part being interposed between the heater tool and the backup member; and a thermal resistor which is interposed between the backup member and the to-be-bonded part.

According to a second aspect of the present invention, there is provided a press-bonding method for thermal press-boding a to-be-bonded part, comprising: interposing the to-be-bonded part between a heater tool and a backup member; interposing a protection member between a distal end portion of the heater tool and the to-be-bonded part; interposing a thermal resistor between the backup member and the to-be-bonded part; and pressing and heating the to-be-bonded part by the heater tool and thermal press-bonding the to-be-bonded part, in a state in which the protection member, the to-be-bonded part and the thermal resistor are clamped between the heater tool and the backup member.

The present invention can provide a press-bonding apparatus and a press-bonding method, which can suppress, without raising a set temperature more than necessary, defective connection at a to-be-bonded part, and can prevent damage to a substrate which constitutes a to-be-bonded part. In addition, a positional displacement at the to-be-bonded part can be prevented, and thermal press-bonding can be carried out with high positional precision, and the work efficiency can be enhanced.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the structure of a display device including a wiring board according to an embodiment of the present invention;

FIG. 2 is a cross-sectional view taken along line A-A in FIG. 1, illustrating the cross-sectional structure of a display panel and a wiring board of the display device;

FIG. 3 is a perspective view that shows, in enlarged scale, the structure of the wiring board shown in FIG. 1;

FIG. 4 is a perspective view of a press-bonding apparatus according to the embodiment of the invention;

FIG. 5 is a front view that shows a thermal press-bonding head and a backup member of the press-bonding apparatus shown in FIG. 4;

FIG. 6 is a side view that shows the thermal press-bonding head and the backup member of the press-bonding apparatus shown in FIG. 4;

FIG. 7 shows a liquid crystal display panel, a wiring board and a driving circuit board, which are connected by thermal press-bonding by the press-bonding apparatus shown in FIG. 4; and

FIG. 8 is a view for describing a thermal press-bonding process which is carried out by the press-bonding apparatus shown in FIG. 4.

### DETAILED DESCRIPTION OF THE INVENTION

Referring now to the accompanying drawings, a description will be given of a manufacturing apparatus and a manufacturing method for a display device according to an embodiment of the present invention, in particular, a press-bonding apparatus and a press-bonding method for connecting a display panel and a wiring board, which constitute the display device.

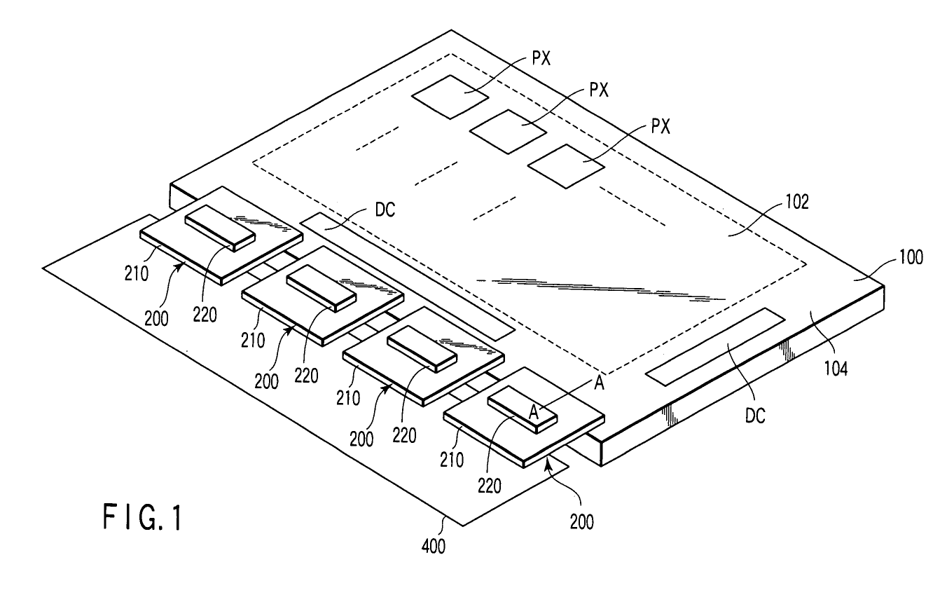

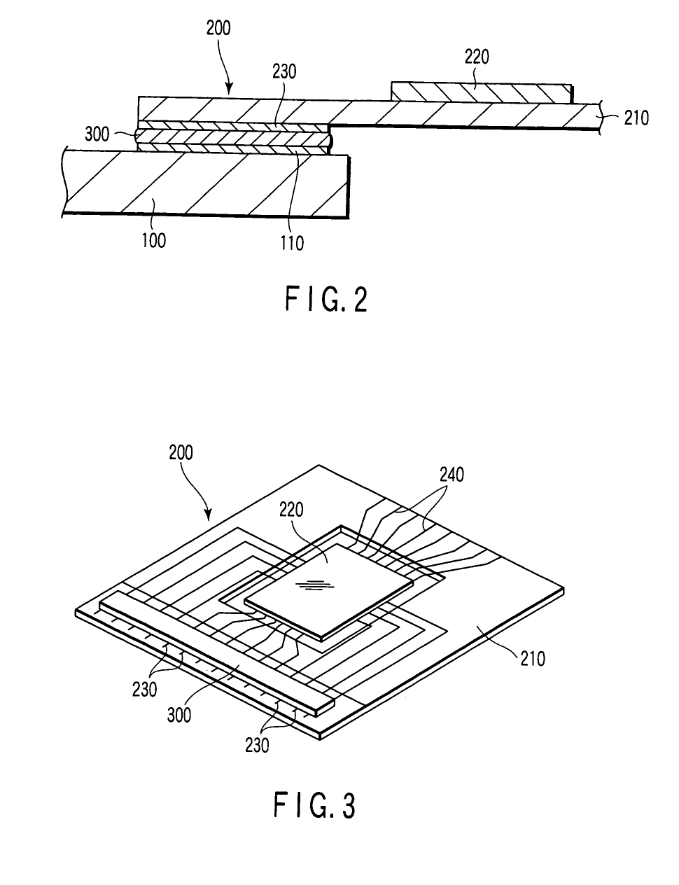

To begin with, the structure of a display device, which is the object of manufacture, is described. As shown in FIG. 1 and FIG. 2, the display device includes a flat-plate-shaped display panel 100. The display panel 100 is formed by using a very thin insulating substrate (glass substrate with a thickness of, e.g. 0.3 mm), and the display panel 100 includes a display area 102 which displays an image. The display area 102 is composed of a plurality of display pixels PX which are arrayed in a matrix. The display panel includes, in a peripheral area 104 surrounding the display area 102, driving circuits DC for generating various driving signals that are necessary for displaying an image (e.g. at least a part of a signal line driving circuit which supplies a video signal to signal lines, and at least a part of a scanning line driving circuit which supplies a control signal to scanning lines). In the peripheral area 104, a plurality of pads 110 are disposed on one side edge portion of the display panel 100.

The display device includes wiring boards 200 which are connected to the display panel 100. The wiring board 200 supplies various signals, which are necessary for displaying an image, to the display panel 100. The wiring board 200 may have a control circuit in itself, or may be connected to a separate driving circuit board.

As is shown in FIG. 3, the wiring board 200 is composed, for example, as a TCP in which a driver IC is mounted by TAB on a flexible printed circuit board 210 having a plurality of wiring patterns. The wiring board 200 includes a plurality of output leads 230, which are disposed at one end of the wiring board 200, and a plurality of input leads 240, which are disposed at the other end of the wiring board 200.

The plural output leads 230 are configured to be electrically connectable to the pads 110 of the display panel 100. Specifically, the output leads 230 are electrically connected to the IC 220, and are arranged with predetermined intervals in consideration of intervals of the pads 110 of the display panel 100.

The plural input leads 240 are configured to be electrically connectable to leads of a driving circuit board 400. Specifically, the input leads 240 are electrically connected to the driver IC 220, and are arranged with predetermined intervals in consideration of intervals of the leads of the driving circuit board 400.

To be more specific, as shown in FIG. 2, the display panel 100 and wiring board 200 are electrically and mechanically connected via a bonding member such as an anisotropic conductive film 300. In other words, the pads 110 of the display panel 100 and the output leads 230 of the wiring board 200 are electrically connected by an electrically conductive material included in the anisotropic conductive film 300, and are mechanically connected by an adhesive included in the anisotropic conductive film 300.

Next, a manufacturing apparatus for manufacturing the above-described display device, in particular, a press-bonding apparatus, is described.

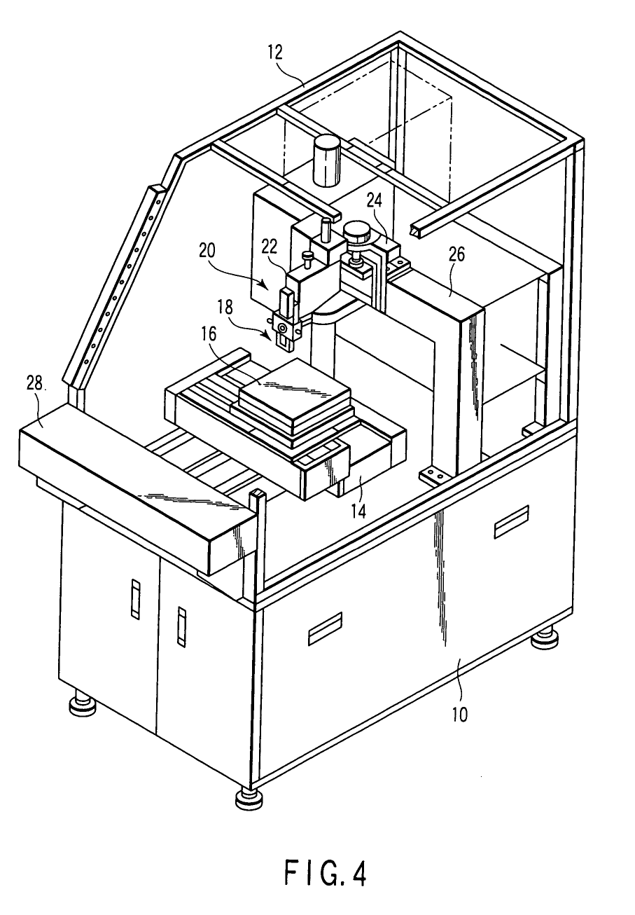

As is shown in FIG. 4, the press-bonding apparatus comprises a base 10 and a support frame 12. An X-Y table 14 is provided on an upper surface of the base 10. A stage 16, on which a work having a to-be-bonded part, such as a display panel, is mountable, is provided on the X-Y table 14.

A head unit 20 including a thermal press-bonding head 18 is provided above the stage 16. The head unit 20 is attached to a movable base 24 via an air cylinder 22. The movable base 24 is provided on a horizontal frame 26 in the support frame 12, the horizontal frame 26 horizontally extending above the stage 16. Thereby, the head unit 20 is supported to be vertically movable, relative to the stage 16, and to be horizontally movable.

An operation panel 28, which controls the operations of the X-Y table 14, air cylinder 22, thermal press-bonding head 18, etc., is provided on a front part of the support frame 12.

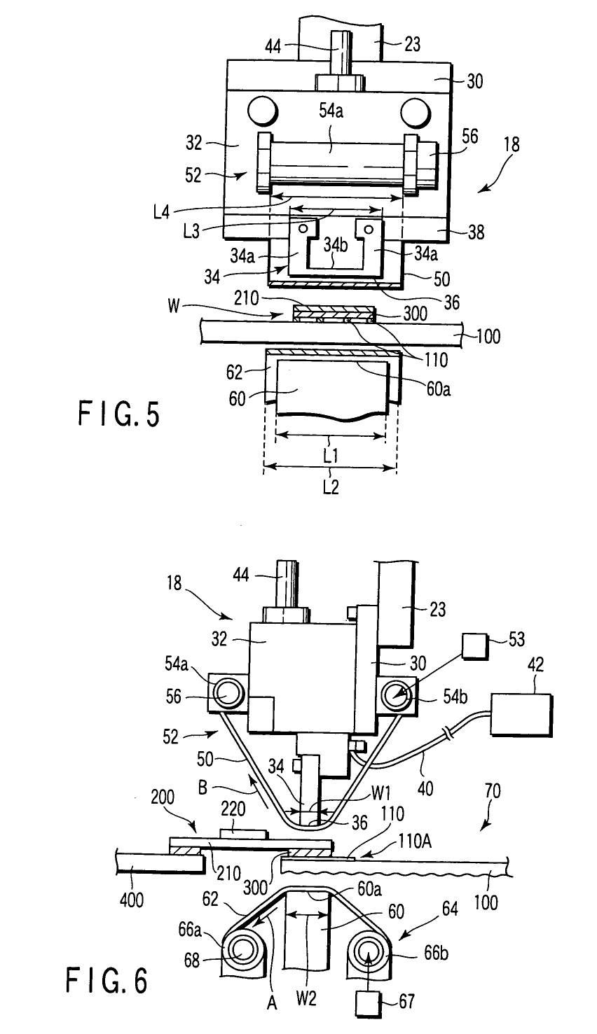

FIG. 5 and FIG. 6 show the thermal press-bonding head 18 of the press-bonding apparatus. As shown in FIG. 5 and FIG. 6, the thermal press-bonding head 18 includes a plate-shaped base unit 30 which is fixed to the air cylinder 22 via a support rod 23; a rectangular support block 32 which is attached to the base unit 30; and a heater tool 34 which is fixed to the support block 32. The support block 32 is attached rotatable relative to the base unit 30, so as to be capable of adjusting the position of the heater tool 34.

The heater tool 34 includes a pair of leg portions 34a, which are parallel to each other and spaced apart with a predetermined distance, and a distal end portion 34b which couples one end of one of the paired leg portions 34a and one end of the other leg portion 34a. The heater tool 34 has a substantially U-shape. A bottom surface 36 of the distal end portion 34b is formed flat, and horizontally extends. The heater tool 34 is formed of a metallic material such as iron, and the distal end portion 34b is formed with a sufficiently small thickness so as to have a high electrical resistance.

The heater tool 34 has their leg portions 34a screwed down to a shank 38 which is fixed to the lower surface of the support block 32, and thus the heater tool 34 is detachably fixed to the support block 32. The shank 38 is formed such that the surface of an electrically conductive material, such as copper, is plated with gold. In addition, the shank 38 is connected to a pulse power supply 42 via a current supply line 40 and to a control unit (not shown). By supplying a pulse current from the pulse power supply 42, the heater tool 34 is supplied with power via the shank 38 and the distal end portion 34b of the heater tool, which has a high electrical resistance, instantaneously produces Joule heat corresponding to the supplied current.

A temperature sensor, such as a thermistor, is attached to the distal end portion 34b of the heater tool 34, and the temperature sensor is connected to the control unit. The heating temperature of the distal end portion 34b is detected by the temperature sensor. The control unit controls the operation of the pulse power supply 42 in accordance with the detected temperature, and sets the heating temperature of the distal end portion 34b at a predetermined temperature.

An adjustment lever 44 is fixed to the upper surface of the support block 32 via a bracket. If a distal end portion of the adjustment lever 44 is pushed, the support block 32 is rotated. Thereby, the heater tool 34 rotates together with the support block 32, and the parallelism of the distal end portion 34b of the heater tool, relative to the to-be-bonded part, can be adjusted.

The press-bonding apparatus also includes a backup member 60 which is provided on the stage 16 side. The backup member 60 is opposed to the lower side of the thermal press-bonding head 18 with a gap. The backup member 60 is formed of, e.g. a metallic material in a rectangular shape, and has a flat support surface 60a which is opposed to a bottom surface 36 of the heater tool 34. The support surface 60a has a width W2 which is greater than a width W1 of the bottom surface 36 at the distal end portion 34b of the heater tool 34. The backup member 60 supports the to-be-bonded part, for instance, one side edge portion 100A of the display panel 100, in cooperation with the pressing of the heater tool 34. The pads 110, which are connected to various wiring lines that are led out from the display area 102, are disposed on the side edge portion 100A.

In the above-described structure, the heater tool 34 is configured to be vertically movable relative to the backup member 60. Specifically, if the heater tool 34 is moved upward, the heater tool 34 moves away from the backup member 60, thus providing a gap between itself and the backup member 60, in which a work W (in this example, the display panel 100 and wiring board 200 which are placed on each other via the anisotropic conductive film 300) can be disposed. If the heater tool 34 is moved downward, the heater tool 34 moves toward the backup member 60 and clamps the work W between itself and the backup member 60. At this time, the heater tool 34 can apply a predetermined pressure to the clamped work W by means of a pressing mechanism (not shown). In addition, the heater tool 34 can apply heat at a predetermined temperature to the clamped work W (e.g. at a temperature at which the anisotropic conductive film 300 lying between the display panel 100 and wiring board 200 can be melted).

A thermal resistor 62 is provided between the backup member 60 and work W. Specifically, the thermal resistor 62 is passed so as to cover the support surface 60a of the backup member 60. The thermal resistor 62 is formed of a material having heat resistance, elasticity and heat retaining properties. In particular, the thermal resistor 62 should preferably be formed of a material with a relatively low heat conductivity, such as a silicone resin. In addition, as shown in FIG. 5, the thermal resistor 62 should preferably have a longitudinal width L2 which is greater than a longitudinal width L1 of the backup member 60. The thermal resistor 62 is formed with a thickness of, e.g. 0.2 mm.

Specifically, in the case where the display panel 100, which is formed of a very thin insulating substrate (a glass substrate with a thickness of 0.3 mm to 0.7 mm), is applied as the work W, the heat of the heater tool 34 tends to be easily radiated to the backup member 60. As a result, sufficient heat cannot be imparted to the work W, leading to defective connection.

Since the thermal resistor 62 is disposed between the display panel 100 and the backup member 60, the heat that is produced from the heater tool 34 is hardly radiated to the backup member 60. It is thus possible to maintain the actual temperature that enables melting of the anisotropic conductive film 300 between the heater tool 34 and thermal resistor 62 and enables sure connection. Therefore, sufficient heat can be imparted to the work W, and occurrence of defective connection can be suppressed. Furthermore, there is no need to raise the set temperature, which is necessary to press-bond the wiring board 200, to a level higher than necessary, and there is no possibility that the components mounted on the display panel 100 are adversely affected.

The thermal resistor 62 also functions as a buffer member for eliminating non-uniformity in planarity on the support surface 60a of the backup member 60 and for absorbing shock that would act on the display panel 100 (in particular the insulating substrate). Even in the case where the thin insulating substrate is used, it becomes possible to prevent damage to the insulating substrate when the wiring board 200 is pressed under the pressure necessary for press-bonding.

The heat conductivity, which is required for the thermal resistor 62, was tested. It was found that in the case of using a glass substrate with a thickness of 0.6 mm or more for the insulating substrate of the display panel 100, the above-described problem did not occur even if the thermal resistor 62 was not disposed. In the case of using a glass substrate with a thickness of 0.5 mm, it was preferable to use a material with a heat conductivity of 1.30 W/m·K or less. In the case of using a glass substrate with a thickness of 0.4 mm, it was preferable to use a material with a heat conductivity of 1.25 W/m·K or less. In particular, in the case of using a glass substrate with a thickness of 0.3 mm, the use of which is desired in the present invention, it was preferable to use a material with a heat conductivity of 1.10 W/m·K or less.

In the press-bonding apparatus with the above-described structure, the thermal resistor 62 is formed of a strip-like sheet. As shown in FIG. 6, the press-bonding apparatus further includes a driving mechanism 66 which runs the strip-like thermal resistor 62 in a predetermined direction (i.e. a direction indicated by arrow A in FIG. 6). Specifically, the driving mechanism 66 comprises a feeding mechanism 66b which feeds the thermal resistor 62 in a direction toward the backup member 60, and a winding mechanism 66a which takes up the thermal resistor 62. Each of the feeding mechanism 66b and winding mechanism 66a includes a rotatable reel. One end portion of the thermal resistor 62 is wound around the rotatable reel of the feeding mechanism 66b, and the other end portion of the thermal resistor 62 is wound around the rotatable reel of the winding mechanism 66a. At least the winding mechanism 66a includes a driving source (driving motor) 68 which imparts a torque to the rotational shaft of the rotatable reel of the winding mechanism 66a so as to be able to run the thermal resistor 62 in the direction of arrow A.

The driving mechanism 66 runs the thermal resistor 62 from the feeding mechanism 66b toward the winding mechanism 66a, in units of a plurality of press-bonding operations, e.g. 200 press-bonding operations, with a predetermined feed amount which is equal to or greater than the width W2 of the support surface 60a of the backup member 60 (i.e. the length of the support surface 60a in a direction parallel to the predetermined direction A of the backup member 60 (the direction of running of the thermal resistor)). If the press-bonding operation is repeated at the same part of the thermal resistor 62, the thermal resistor 62 may be degraded and damaged. In addition, the performance for maintaining the actual temperature deteriorates due to the variation in physical properties of the thermal resistor, leading to defective connection of the wiring board 200 and damage to the insulating substrate. To cope with this problem, the thermal resistor 62 is replaced by feeding, each time a predetermined number of press-bonding operations are executed. Thereby, a stable press-bonding operation is enabled, and defective connection and damage to the substrate can be prevented.

The driving mechanism 66 further includes a tension mechanism 67 which imparts tension to the thermal resistor 62. The tension mechanism 67 is provided, for example, on the feeding mechanism 66b side. The tension mechanism 67 locks the rotatable reel of the feeding mechanism 66b, or rotates the rotatable reel of the feeding mechanism 66b in order to pull the thermal resistor 62 in a direction opposite to the direction of arrow A. Thereby, predetermined tension is imparted to the thermal resistor 62 between the feeding mechanism 66b and winding mechanism 66a, in particular, at the support surface 60a of the backup member 60. Therefore, the occurrence of defective connection of the wiring board 200 due to the slack of the thermal resistor 62 can be suppressed.

A protection member 50 is disposed between the heater tool 34 and the work W. Specifically, the protection member 50 is so passed as to cover the bottom surface 36 of the heater tool 34. The protection member 50 protects the heater tool 34 against adherence of an adhesive or other foreign matter included in the anisotropic conductive film 300 when the heater tool 34 comes in contact with the work W. The protection member 50 is formed of a material with heat resistance and elasticity. In particular, it is preferable that the protection member 50 be formed of a sheet material with a relatively high heat conductivity, such as a sheet of Teflon (polytetrafluoroethylene resin). In addition, the protection member 50 also functions as a buffer member for eliminating non-uniformity in planarity on the bottom surface 36 of the heater tool 34, and the pressure that is imparted by the heater tool 34 can uniformly be transmitted to the work W. As is shown in FIG. 5, the protection ember 50 should preferably have a longitudinal width L4 which is greater than a longitudinal width L3 of the heater tool 34. The protection member 50 is formed to have a less film thickness than the thermal resistor 62, and the protection member 50 has a thickness of, e.g. 0.08 mm.

In the press-bonding apparatus with the above-described structure, the protection member 50 is formed of a strip-like sheet. As shown in FIG. 6, the press-bonding apparatus further includes a driving mechanism 52 which runs the strip-like protection member 50 in a predetermined direction (i.e. a direction indicated by arrow B in FIG. 6). Specifically, the driving mechanism 52 comprises a feeding mechanism 54b which feeds the protection member 50 in a direction toward the heater tool 34, and a winding mechanism 54a which takes up the protection member 50. Each of the feeding mechanism 54b and winding mechanism 54a includes a rotatable reel. One end portion of the protection member 50 is wound around the rotatable reel of the feeding mechanism 54b, and the other end portion of the protection member 50 is wound around the rotatable reel of the winding mechanism 54a. At least the winding mechanism 54a includes a driving source (driving motor) 56 which imparts a torque to the rotational shaft of the rotatable reel of the winding mechanism 54a so as to be able to run the protection member 50 in the direction of arrow B.

The driving mechanism 52 runs the protection member 50 from the feeding mechanism 54b toward the winding mechanism 54a, in units of a plurality of press-bonding operations, with a predetermined feed amount which is equal to or greater than the width W1 of the bottom surface 36 of the heater tool 34 (i.e. the length in a direction parallel to the predetermined direction B of the heater tool 34 (i.e. the direction of running of the protection member)). Thereby, a stable press-bonding operation is enabled, and defective connection and damage to the substrate can be prevented.

The driving mechanism 54 further includes a tension mechanism 53 which imparts tension to the protection member 50. The tension mechanism 53 is provided, for example, on the feeding mechanism 54b side. The tension mechanism 53 locks the rotatable reel of the feeding mechanism 54b, or rotates the rotatable reel of the feeding mechanism 54b in order to pull the protection member 50 in a direction opposite to the direction of arrow B. Thereby, predetermined tension is imparted to the protection member 50 between the feeding mechanism 54b and winding mechanism 54a, in particular, at the bottom surface 36 of the heater tool 34. Therefore, the occurrence of defective connection of the wiring board 200 due to the slack of the protection member 50 can be suppressed.

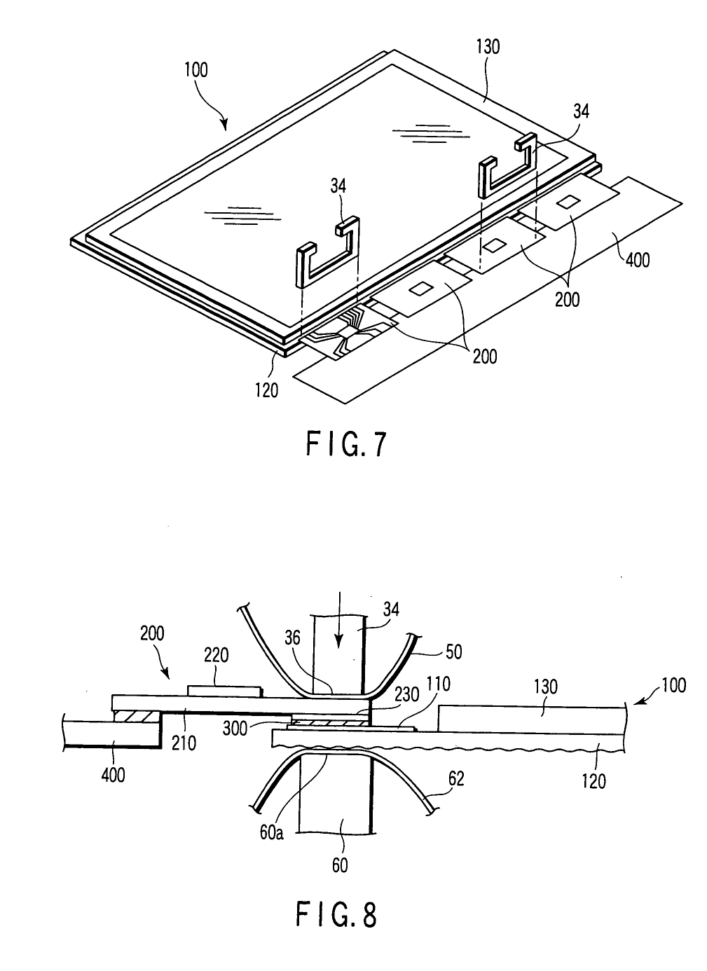

Next, the press-bonding operation of the press-bonding apparatus with the above-described structure is described. In this description, a liquid crystal display panel, for example, is used for the display panel 100 to which the wiring board 200 is to be thermally press-bonded. As shown in FIG. 7, a liquid crystal display panel 100 includes an array substrate 120 and a counter-substrate 130, which are disposed to be opposed to each other with a predetermined gap, and liquid crystal layer (not shown) which is sealed between these substrates. Each of the array substrate 120 and counter-substrate 130 is formed of a thin glass plate with a thickness of 0.3 mm. A conductor pattern including signal lines and scanning lines is formed on the array substrate 120. In a peripheral area of the array substrate 120, a plurality of pads 110 (see, e.g. FIG. 2), which are electrically connected to the conductor pattern, are disposed in parallel with each other at predetermined intervals.

Each of a plurality of wiring boards 200, which are connected to the array substrate 120, includes a rectangular flexible printed circuit board 210 and a driver IC 220 for driving, which is mounted on the board 210. The wiring board 200 includes many output leads 230, which are provided on one end side of the wiring board 200, and many input leads 240, which are provided on the other end side of the wiring board 200. The output leads 230 are electrically connected to the driver IC 220, and are arranged in parallel at substantially the same intervals as the pads 110 of the array substrate 120. The input leads 240 are electrically connected to the driver IC 220 and are arranged in parallel at substantially the same intervals as leads (not shown) of a driving circuit board 400.

Prior to the press-bonding operation, the liquid crystal display panel 100 and wiring boards 200 are prepared.

To begin with, as shown in FIG. 3, an elongated sheet-shaped anisotropic conductive film 300 is attached on the many output leads 230 that are provided on one end side of the wiring board 200. The anisotropic conductive film 300 is formed in a sheet shape, for example, by dispersing electrically conductive particles of, e.g. nickel or solder, in a thermosetting resin.

Then, as shown in FIG. 7, while predetermined pads 110 provided on the liquid crystal display panel 100 and the output leads 230 of the wiring board 200 are being exactly aligned, one end portion of the wiring board 200 is placed on the display panel 100 with the anisotropic conductive film 300 interposed. Thus, provisional press-bonding is performed. In this state, the liquid crystal display panel 100 and the plural wiring boards 200 are placed on the stage 16 of the press-bonding apparatus.

Subsequently, as shown in FIG. 5 and FIG. 6, the X-Y table 14 is driven through the operation panel 28 and the stage 16 is moved to a position where the provisional press-bonded part between the liquid crystal display panel 100 and the wiring board 200, that is, the to-be-bonded part, is aligned between the distal end portion 34b of the heater tool 34 and the backup member 60. In this state, the protection member 50 is interposed between the distal end portion 34b of the heater tool 34 and the to-be-bonded part of the wiring board 200, and the thermal resistor is interposed between the support surface 60a of the backup member 60 and the back surface of the liquid crystal display panel 100.

Thereafter, as shown in FIG. 8, the air cylinder 22 is driven to lower the thermal press-bonding head 18. The bottom surface 36 of the distal end portion 34b of the heater tool 34 is pushed downward on the to-be-bonded part of the wiring board 200, and the wiring board 200 is pressed on the liquid crystal display panel 100 under a predetermined pressure. At this time, the bottom surface 36 of the heater tool 34 pushes the wiring board 200 with the protection member 50 interposed. At the same time, the back surface of the liquid crystal display panel 100 (i.e. the outer surface of the array substrate 120) is supported on the support surface 60a of the backup member 60, and the wiring board 200, anisotropic conductive film 300 and array substrate 120 are clamped between the backup member 60 and heater tool 34. At this time, the thermal resistor 62 is interposed between the support surface 60a of the backup member 60 and the array substrate 120. The thermal resistor 62 elastically deforms along the back surface of the array substrate 120 and comes in close contact with the back surface of the array substrate 120. Thereby, a positional displacement of the wiring board 200 and liquid crystal display panel 100, relative to the heater tool 34 and backup member 60, is prevented.

In this state, power is supplied from the pulse power supply 42 for a predetermined time, thereby heating the heater tool 34. In this manner, the wiring board 200, array substrate 120 and anisotropic conductive film 300 are pressed, while being heated, by the heater tool 34. Thereby, the to-be-bonded part is mechanically and electrically press-bonded by main press-bonding, with the anisotropic conductive film 300 being interposed. Specifically, the adhesive included in the anisotropic conductive film 300 is melted, and the electrically conductive material is bitten between the pads 110 and output leads 230. At the time of this main press-bonding, the bottom surface 36 of the heater tool 34 is covered with the protection member 50. Thus, even if an excess portion of the molten anisotropic conductive film 300 flows out, the protection member 50 captures the excess anisotropic conductive film and prevents it from adhering to the heater tool 34.

Subsequently, power to the heater tool 34 is stopped, and the temperature of the heater tool 34 is decreased to a predetermined level. Then, the air cylinder 22 is driven to raise the head unit 20.

By the above-described operation, the resin of the anisotropic conductive film 300 is heated and once softened and pressed. The resin is then cooled and solidified, and thus the wiring board 200 is fixed to the array substrate 120 of the display panel 100. At the same time, the pads 110 of the display panel 100 are electrically connected to the output leads 230 of the wiring board 200 by the electrically conductive particles that are dispersed in the resin of the anisotropic conductive film 300.

On the other hand, the input leads 240 that are provided on the other end part of the wiring board 200 are connected to electrodes (not shown) of the driving circuit board 400 by the same operation as described above. In this case, however, solder is used in place of the anisotropic conductive film.

At a time when the protection member 50 is stained, or at regular time intervals, the winding mechanism 54a is driven to take up the protection member 50, thereby moving a new non-used part of the protection member 50 to a position facing the distal end portion of the heater tool 34. Similarly, at a time when the thermal resistor 62 is stained, or at regular time intervals, the winding mechanism 66a is driven to take up the thermal resistor 62, thereby moving a new non-used part of the thermal resistor 62 to a position facing the support surface 60a of the backup member 60.

In this embodiment, in every 200 press-bonding operations, the thermal resistor 62 is replaced by feeding, and the feed amount of the thermal resistor 62 is set at 5 mm while the width W2 of the support surface 60a is about 3 mm. With these settings, the press-bonding operation was repeated, and it was found that there occurred no defective connection or damage to the insulating substrate.

According to the press-bonding apparatus with the above-described structure and the press-bonding method, the protection member 50 with elasticity is provided between the heater tool 34 and the to-be-bonded part. Even if there is some unevenness on the to-be-bonded part, the bottom surface of the heater tool 34 can be brought into close contact with the to-be-bonded part via the protection member 50. Furthermore, even if an excess portion of the anisotropic conductive film flows out, the protection member 50 prevents it from adhering to the heater tool 34 and prevents the heater tool 34 from being stained.

Since the thermal resistor 62 with elasticity is provided between the support surface 60a of the backup member 60 and the to-be-bonded part, the support surface 60a of the backup member 60 abuts on the display panel 100 via the thermal resistor 62. Thus, even if the display panel 100 is formed by using a glass substrate such as a thin glass plate with non-uniformity in thickness and fine unevenness over the entire polished surface, the thermal resistor 62 elastically deforms along the bottom surface of the glass substrate and comes in close contact with the back surface of the glass substrate. Therefore, the non-uniformity in thickness of the glass substrate can be eliminated by the thermal resistor 62, and the support surface 60a of the backup member 60 can be brought into close contact with the glass substrate via the thermal resistor 62. Hence, a positional displacement of the wiring board 200 and liquid crystal display panel 100, relative to the heater tool 34 and backup member 60, can be prevented, and the to-be-bonded part can be thermally press-bonded with high positional precision.

Furthermore, since the thermal resistor 62 has heat retaining properties, the thermal resistor 62, which is in contact with the glass substrate of the display panel 100, retains the heat of the glass substrate, and a decrease in temperature of the to-be-bonded part can be suppressed. Even in the case where a thin glass plate with a thickness of about 0.3 mm is used as the glass substrate, there is no need to raise the set temperature for heating the heater tool 34. Glass plates with thicknesses in a range of 0.3 mm to 0.7 mm can be subjected to thermal press-bonding under the common conditions. It is not necessary, therefore, to adjust the heating temperature, the parallelism of the heater tool, etc. in accordance with the thickness of the glass plate used, and the work efficiency can be enhanced.

It is thus possible to provide a thermal press-bonding method and a thermal press-bonding apparatus with enhanced work efficiency, which can perform thermal press-bonding with high positional precision, while preventing positional displacement of the components.

The present invention is not limited directly to the above-described embodiments. In practice, the structural elements can be modified without departing from the spirit of the invention. Various inventions can be made by properly combining the structural elements disclosed in the embodiments. For example, some structural elements may be omitted from all the structural elements disclosed in the embodiments. Furthermore, structural elements in different embodiments may properly be combined.

For example, the press-bonding method and press-bonding apparatus according to the present invention are applicable not only to the connection between the display panel and the wiring board or the connection between the wiring board and the driving circuit board, but also to connection between other components. The above-described embodiment is directed to the method of connection via the anisotropic conductive film, but the invention is applicable to connection using solder. Further, in the above-described embodiment, the heat tool is exemplified as the pulse heat tool which receives a pulse current from the pulse power supply, but it may be a continuous-power heat tool which is supplied with a constant current from a power supply.

The materials of the protection member and thermal resistor are not limited to those described in the embodiment, and various materials may be selected, as needed.

In the above-described embodiment, the display device may be a self-luminous display device such as an organic EL (electroluminescence) display device, or may be a liquid crystal display device. In the case of the organic EL display device, the display panel 100 is configured such that each of the display pixels PX includes a pixel circuit and a display element that is driven and controlled by the pixel circuit. In the case of the liquid crystal display panel, the display panel 100 is configured such that a liquid crystal layer is held between a pair of substrates and each of the display pixels PX includes a display element, in which the liquid crystal layer is held between a pixel electrode and a counter-electrode, and a switching element which writes a predetermined potential in the pixel electrode.

What is claimed is:

1. A press-bonding apparatus comprising:
a backup member which supports a to-be-bonded part;
a heater tool which presses and heats the to-be-bonded part, with the to-be-bonded part being interposed between the heater tool and the backup member; and
a thermal resistor which is interposed between the backup member and the to-be-bonded part.

2. The press-bonding apparatus according to claim 1, wherein the thermal resistor is a strip-like sheet, and
the press-bonding apparatus further comprises a driving mechanism which runs the thermal resistor in a predetermined direction.

3. The press-bonding apparatus according to claim 2, wherein the driving mechanism runs the thermal resistor, each time a predetermined number of press-bonding operations are performed, with a feed amount which is equal to or greater than a width of the backup member in a direction parallel to a direction of running of the thermal resistor.

4. The press-bonding apparatus according to claim 1, further comprising a tension mechanism which imparts tension to the thermal resistor.

5. The press-bonding apparatus according to claim 1, wherein the thermal resistor is formed of a silicone resin.

6. The press-bonding apparatus according to claim 1, wherein the thermal resistor has a heat conductivity of 1.10 W/m·K or less.

7. The press-bonding apparatus according to claim 1, further comprising a protection member which is interposed between the heater tool and the to-be-bonded part.

8. The press-bonding apparatus according to claim 1, wherein the to-be-bonded part includes a glass substrate with a thickness of 0.3 mm to 0.7 mm.

9. The press-bonding apparatus according to claim 7, wherein the thermal resistor has a thickness which is greater than a thickness of the protection member.

10. The press-bonding apparatus according to claim 7, wherein the protection member is formed to have a thickness of 0.08 mm.

11. The press-bonding apparatus according to claim 7, wherein the protection member is formed of polytetrafluoroethylene resin.

12. The press-bonding apparatus according to claim 1, wherein the thermal resistor is formed to have a thickness of 0.2 mm.

13. A press-bonding method for thermal press-boding a to-be-bonded part, comprising:
interposing the to-be-bonded part between a heater tool and a backup member;
interposing a protection member between a distal end portion of the heater tool and the to-be-bonded part;
interposing a thermal resistor between the backup member and the to-be-bonded part; and
pressing and heating the to-be-bonded part by the heater tool and thermal press-bonding the to-be-bonded part, in a state in which the protection member, the to-be-bonded part and the thermal resistor are clamped between the heater tool and the backup member.
